(19) United States
(12) Patent Application Publication
(10) Pub. No.: US 2023/0021877 A1
(43) Pub. Date: Jan. 26, 2023

(54) METHOD FOR OPERATING A MULTIMEDIA SYSTEM, COMPUTER PROGRAM AS WELL AS MULTIMEDIA SYSTEM

(71) Applicant: MERCEDES-BENZ GROUP AG, Stuttgart (DE)

(72) Inventors: Hans WICKLER, Sunnyvale, CA (US); Ting-Wei HSU, Mountain View, CA (US)

(21) Appl. No.: 17/785,985

(22) PCT Filed: Nov. 2, 2020
(86) PCT No.: PCT/EP2020/080663

§ 371 Date: Jun. 16, 2022

(30) Foreign Application Priority Data
Dec. 17, 2019 (GB) GB1918604.8

(51) Int. Cl. H04W 4/44; H04L 67/306; H04L 65/60

(52) U.S. Cl. CPC H04W 4/44; H04L 67/306; H04L 65/60; H04W 88/06

(57) ABSTRACT

A method for operating a motor vehicle multimedia system involves establishing a first mobile network connection between a cloud server external to the motor vehicle and a multimedia device internal to the motor vehicle and establishing a second mobile network connection between the cloud server and a mobile device. A user setting for the mobile device from the user is transferred from the mobile device to the cloud server using the second mobile network connection and the user setting is stored at the cloud server so that the multimedia device can directly access this user setting by just using the first mobile network connection. The multimedia device and the mobile device are synchronized by the cloud server and an offline work with the mobile device or the multimedia device is stored and after a connection from the mobile device or the multimedia device to the cloud server the mobile device and the multimedia device are synchronized.

### FIELD OF THE INVENTION

Exemplary embodiments of the invention relate to a method for operating a multimedia system for a motor vehicle, a computer program, as well as to a multimedia system.

### BACKGROUND INFORMATION

According to the state of the art, the ability to store a user information in such a way as to be simply, competition efficient and user friendly enough to facilitate a personalized eco system based on individual user preferences is needed. Furthermore, it is known that a connection between the mobile device and the multimedia device of the car can be realized

Furthermore, DE 10 2017 215 496 A1 shows a vehicle multimedia system having at least one display, a radio headunit, the radio headunit having a graphic processing unit, a display controller, an input device, a Wayland/Weston compositor, and a communication handler and having a data connection via the vehicle bus system, the data connection via the vehicle bus system leading to data exchange with a smartphone. It is shown that a two stage composition for the rendering of the graphics of the vehicle multimedia system to be displayed takes place via the data link via the vehicle bus system and, for this purpose, the first stage of the compositing is transferred to the smartphone via the data link using the smartphone graphics hardware.

US 2019/0265884 A1 shows a method for interfacing a mobile device with a vehicle. The method includes providing a connection to the Internet for the vehicle via wireless connection circuitry associated with an on-board computer of the vehicle. The connection used to communicate with a server of a cloud service provider for the vehicle. The cloud service provider is configured to manage user accounts to enable one or more vehicles to connect with the cloud service provider. A user account is assigned to a user and the user account is associated with custom settings of the user. The method includes enabling communication, by the on-board computer, with a mobile device proximate to the vehicle. The communication provides for pairing the mobile device with the on-board computer using credentials saved by the on-board computer from a previous pairing or pairing the mobile device with the on-board computer via a pairing routine processed between the on-board computer and the mobile device.

US 2017/0072883 A1 suggests a system and a method for reconfiguring a vehicle based on one or more preferences of a first user without the first user directly providing an input to the vehicle to reconfigure the vehicle. The method may include wirelessly receiving first user profile data at a vehicle. The first user profile data may be associated with a first user. The first user profile data may describe how one or more settings of the vehicle should be configured for the first user.

US 2012/0174212 A1 describes a connected account provider system that allows a user of multiple electronic devices to set up a user account on one device with the device's settings saved in the cloud for application across different devices. A user can obtain secure access to the saved settings using a second (or subsequent) device and can select settings from the initial device to be synchronized to the second device.

Exemplary embodiments of the invention are directed to a method, a computer program as well as a multimedia system, allowing a more efficient operation of the multimedia system.

### SUMMARY OF THE INVENTION

One aspect of the invention relates to a method for operating a multimedia system for a motor vehicle, wherein a first mobile network connection is established between a cloud server of the multimedia system external to the motor vehicle and a multimedia device of the multimedia system internal to the motor vehicle and wherein a second mobile network connection is established between the cloud server and a mobile device of a user of the multimedia system.

The at least one user setting for the mobile device from the user is transferred from the mobile device to the cloud server by using the second mobile network connection and this at least one user setting is stored at the cloud server, so that the multimedia system can directly access this user setting by just using the first mobile network connection.

Additionally, the multimedia device and the mobile device are synchronized by the cloud server. In particular, a cloud storage is needed to synchronize the applications a user has chosen to use in the vehicle's headunit. Here, a cloud storage contains profiled data in key/value pairs for the application's state. The user stores profile data in application states on the cloud storage. For example, a bucket is created to store a user's data, where the data can be viewed or moved at any time. When the data is removed, the bucket that contains the data, can be deleted. The user can then synchronize the data in the cloud with data on the motor vehicle, in this case, for example, using a special synchronization program. A service provides a local cache for data to allow applications to read and write data without connectivity. When the device is connected, data in the local cache will synchronize to the cloud and notify the headunit when an update is available. When the headunit is turned on, the user can download content from cloud storage to the vehicle. This is equally applicable to stored files such as photos, videos, or documents. The user is able to access on the vehicle the same personal applications as installed on a smart device. The user may also use digital applications that share the same data of applications that are sharing the same credentials.

Furthermore, an offline work with the mobile device is stored and after the connection from the mobile device and/or the multimedia device to the cloud server the mobile device and the multimedia device are synchronized. In other words, user can synchronize their smart devices and their motor vehicles remotely using the cloud. Using the cloud, user can store their data, preferences, and states, and update their devices or the vehicle's headunit after login. The user is able to work offline and store the changes in a local data base first when there is no connectivity and update later when the connectivity is back. According to a further advantageous embodiment, In a further advantageous form of configuration,

Thereby, it is facilitated that the access from the user to the applications and services can be realized in an easy way. Furthermore, this realization comes with a benefit of being able to utilize existing technologies for connectivity, security, and cloud infrastructures from service providers. For an example, the user will not need to bring and connect the mobile device every time to the multimedia device of the motor vehicle.

In other words, the goal of the invention is to store a user's information in such a way as to be simple, computation efficient, and user friendly enough to facilitate a personalized ecosystem based on individual user preferences. The solution presented is a methodology to upload user device/smartphone settings to a motor vehicle's hosted services that are facilitated by a cloud server connected headunit with the ability to take functions of the mobile devices.

It shall be noted that the described approach is given as an example to illustrate an otherwise general approach to the methodology to upload user setting to cloud hosted services. This is in reference to other or emergent protocols that could be applied, but that would not change the solution of this invention. It shall be noted that user applications in this context are executables supplied by third party providers through app stores, and the term ‘user setting’ relates to the personalized user preferences and stored data associated with that applications. It shall further be noted that the application is not limited for use with a motor vehicle or headunit of the motor vehicle or the multimedia device of the motor vehicle, but is rather general in concept and could equally be applied to a home or office application where the function of the headunit is operated by home or office based computing platforms that have at least a network connection to a cloud server.

The mobile device can, for example, be a smartphone or a tablet or any other user devices that could run the user application. The mobile device is further described as a smartphone and can equally be a computerized platform or an IoT device that can be connected to a cloud service.

In an advantageous form of configuration, the multimedia device is using the at least one user setting, wherein the mobile device is disconnected from the cloud server. In other words, there is no mobile network connection between the mobile device and the cloud server. Furthermore, there is no connection between the mobile device and the multimedia device. The multimedia device is just obtaining the user setting from the cloud server. Therefore, it is possible that the user setting of the mobile device can be used by the multimedia device without any connection to the mobile device.

Further, it has turned to be advantageous if the at least one user setting can be used by the user by operating the multimedia device. In other words, it is possible, that the user can operate with or at the multimedia device, for example, by touching the multimedia device when the multimedia device is a touchscreen, without any connection to the mobile device. The interaction is just between the multimedia device and the cloud server. So, there is no need for a direct connection between the mobile device and the multimedia device.

According to a further advantageous embodiment, at least one credential for using the user setting is submitted by operating the multimedia device. Especially, once the motor vehicle is configured to the information of the applications or the user settings that now run on the motor vehicle and the relevant preferences of a user had set up on the mobile device, the user can then access the applications through the motor vehicle. In general, a user is required to provide credentials for individual applications. To avoid the need of entering credentials for each application every time the application is accessed and the user credentials may be stored on the motor vehicle's headunit, in other words the multimedia device.

In a further advantageous form of configuration, the at least one credential is stored by the multimedia device. For example, a script can be implemented on the motor vehicle's headunit that stores the credentials. Here, a user needs to provide the credentials for the first attempt to access this application on the vehicle's headunit. Once a successful login has been granted, the credentials may be stored in a script so subsequent use of the applications on the vehicle's headunit will not prompt user to provide them, as the script will inject a stored login form, fetch and hash the credentials, and send it to the applications of the indication servers for log in. Note the script should use local state of the art encryption or a remote server. Furthermore, a software running in the background of the motor vehicle's headunit will need to detect when a user is launching an application requiring credentials and whether it is a new application from a previously defined template. The software will then fetch the previously safe credentials on the vehicle's headunit and submit the credential for a user. The software needs to be installed and maintained on the vehicle's headunit where applications are launched.

Further, it has turned out to be advantageous if the at least one user setting is used for a phone call, a message service, mobile device applications, and/or data of the mobile device. In particular, here, the user setting contains information such as data, for example, for a contact, documents or photos, or texts/calls and applications, in particular including credentials. This methodology assumes that the service of, for example, wireless LAN or cellular provider service is established.

A further aspect of the invention relates to a computer program comprising instructions, which, when the program is executed by a multimedia system, causes the multimedia system to carry out the method according to the preceding aspect.

Another aspect relates to a multimedia system for a motor vehicle with at least a cloud server and a multimedia device, wherein the multimedia system is configured to carry out a method according to the preceding aspect.

Further advantageous embodiments of the method are to be regarded as advantageous embodiments of the computer program and the multimedia system. The multimedia system as well as the computer program for this purpose comprise substantive features, which facilitate a performance of the method or advantageous embodiment thereof.

### BRIEF DESCRIPTION OF THE DRAWINGS

Further advantages, features and details of the invention derive from the following description of preferred embodiments as well as from the drawings. The features and the feature combinations previously mentioned in the description as well as the features and the feature combinations mentioned in the following description of the figure or shown in the figure alone can be employed not only in the respectively indicated combination but also in any other combination or taken alone without leaving the scope of the invention.

FIG. 1 is a schematic view of a multimedia system.

FIG. 2 is another schematic view of a multimedia system.

FIG. 3 is another schematic view of a multimedia system.

FIG. 4 is another schematic view of a multimedia system.

FIG. 5 is another schematic view of a multimedia system.

FIG. 6 is another schematic view of a multimedia system.

### DETAILED DESCRIPTION

In the figures, same elements and elements having the same function are equipped with the same reference signs.

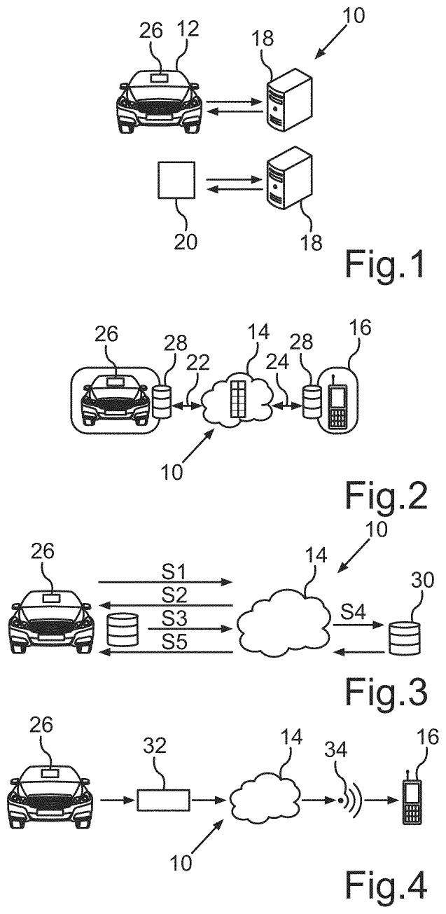

FIG. 1 shows in a schematic view an embodiment of a multimedia system 10 for a motor vehicle 12. The multimedia system 10 comprises at least a cloud server 14 (FIG. 2) and a multimedia device 16 (FIG. 2). In FIG. 1 the motor vehicle 12 can have a connection to a third party application authentication server 18. Furthermore, the third party application authentication server 18 can have a connection to a user setting 20 for the mobile device 16 from a user.

FIG. 1 shows a method for operating the multimedia system 10 for the motor vehicle 12, wherein a first mobile network connection 22 (FIG. 2) is established between the cloud server 14 of the multimedia system 10 external to the motor vehicle 12 and the multimedia device 26 of the multimedia system 10 internal to the motor vehicle 12 and wherein a second mobile network connection 24 (FIG. 2) is established between the cloud server 14 and a mobile device 16.

At least the user setting 20 for the mobile device 16 from the user is transferred from the mobile device 16 to the cloud server 14 by using the second mobile network connection 24 and this at least one user setting 20 is stored at the cloud server 14, so that the multimedia device 26 can directly access this user setting 20 by just using the first mobile network connection 22, in particular without any connection to the mobile device 16.

In particular, the multimedia device 26 is using the at least one user setting 20, wherein the mobile device 16 is disconnected to the cloud server 14. In particular, the at least one user setting 20 can be used by the user by operating of the multimedia device 26, for example, if the multimedia device 26 is built as a touchscreen.

In other words, FIG. 1 shows that the goal of the invention is to store a user information, which is in particular the user setting 20, in such a way as to be simple, computation efficient, and user-friendly enough to facilitate a personalized ecosystem based on individual user preferences. The solution presented here is a methodology of uploading user device/smartphone settings to the motor vehicle's 12 hosted services that are facilitated by the cloud server 14 connected multimedia device 26 with the ability to take the function of the mobile device 16. Here, the user setting 20 contains information such as data, texts/calls, and applications. In other words, the at least one user setting 20 is used for a phone call, a message service, mobile device 26 applications, and/or data of the mobile device 16.

The first mobile network connection 22 and/or the second mobile network connection 24 can be a service of either wireless LAN or a cellular provider service.

It is shown that the mobile device 16 can be a smartphone. It is also possible that the mobile device 16 can be a tablet or any other user device that could run the user application as further described as the smartphone and can equally be a computerized platform or an IoT device that can be connected to the cloud server 14.

To use this smartphone application directly via the multimedia device 26, the user must agree to such use and provide credentials 36 (FIG. 6) for each application on the vehicle. The motor vehicle 12 will safely provide credentials 36 on its private server for future use. Note that the user will choose individual applications and add credentials 36 for each newly added application. Credentials 36 for an application need to be provided only once, the user will then be able to access the chosen application without reentering credentials 36. Credentials 36 are a trusted form of established user identification.

In this context, there is no need to connect or open the application on the smartphone, instead the user will interact with the application via the vehicle user interface. The application will be automatically updated by the application's authentication server. For example, a user is accessing the third party application authentication server 18 on the headunit to make a change. The third party application authentication server 18 will remember that change. When the user accesses the third party application authentication server 18 on the smartphone, the change is already made.

FIG. 2 shows a schematic view of the multimedia system 10. FIG. 2 shows especially that the multimedia device 26 and the mobile device 16 can be synchronized by the cloud server 14. For example, a cloud storage is needed to synchronize the applications a user has chosen to use the motor vehicle's 12 headunit. Here, a cloud storage contains profiled data in key/value pairs for the application state. The user stores profile data in application states on the cloud storage. Here, for example, a bucket is created to store user data, where the data can be viewed or moved at any time. When the data is removed, the bucket that contains the data can be deleted. The user can then synchronize the data in the cloud server 14 with data on the motor vehicle 12. A service provides a local cache 28 for data to allow applications to read and write data without connectivity. When the mobile device 16 is connected, data in the local cache 28 will synchronize to the cloud server 14 and notify the multimedia device 26 when an update is available. When the headunit, which is the multimedia device 26, is turned on, the user can download content from the cloud storage to the motor vehicle 12. This is equally applicable to stored files, such as photos, videos, or documents. The user is able to access on the motor vehicle 12 the same personal applications as installed on the mobile device 16.

Furthermore, FIG. 2 shows that at least one credential 36 for using the user setting 20 is submitting by operating the multimedia device 26. In particular, the at least one credential 36 is stored by the multimedia device 26. Once the vehicle is configured with the information of the applications that now run on the motor vehicle 12 and the relevant preferences, a user had set up on the mobile device 16, the user can then access these applications directly on the motor vehicle 12. In general, a user is required to provide credentials 36 for individual applications. To avoid the need of entering credentials 36 for each application every time the application is accessed, the user credentials 36 may be stored in the multimedia device 26. A script can be implemented on the multimedia device 26 to store the credentials 36. Here, a user needs to provide the credentials 36 for the first attempted to access this application on the vehicle's headunit. Once, a successful access has been granted, the credentials 36 may be stored in a script. Accordingly, a subsequent use of the application on the vehicle's headunit will not prompt the user to provide credentials 36, as the script will inject a stored login form, fetch and hash the credentials 36, and send it to the application's authentication server for log in. Note the script should use local state of the art encryption or remote service. Furthermore, it is possible that software running in the background of the multimedia device 26 will need to detect when the user is launching an application requiring credentials 36 and whether it is a new application from a previously defined template. The software will then fetch the previously saved credentials 36 on the motor vehicle's 12 headunit and submit the credentials 36 for user. The software needs to be installed and maintain on the vehicle's headunit where applications are launched.

FIG. 3 shows another schematic view of the multimedia system 10. FIG. 3 shows that an application of the authentication process from the multimedia device 26 to an authentication server 30 can be done. In a first step S1, the user opens the application, for example, third party application, on the multimedia device 26 that then sends access requests to the application server. In a second step S2, the application server then sends an application form back for the user to complete. In a third step S3, if it is first time access to the application, the user is required to fill out the form with credentials 36 and then return to the application server by the multimedia device 26. In a fourth step S4, the application server sends the credentials 36 to its authentication data base 30 for verification. In a fifth step S5, once authenticated, the application server grants the user access to the web page and the multimedia device 26 may store the user ID and password in the multimedia device 26 credential 36 database if so chosen. If the application URL has been successfully accessed, the multimedia device 26 will, if enables to do the step S3, and then send the user ID and password from the credential 36 data base to the application server 13.

FIG. 4 shows in another schematic view an embodiment of the multimedia system 10. FIG. 4 shows how a user can text a message or make a phone call in the motor vehicle 12. The user will be able to access text messages and calls on the multimedia device 26 directly through, for example, wireless LAN connection with a wireless communication service provider. Here, there is no need to synchronize calls or messages because the mobile carrier will update the mobile device 16 simultaneously when a text or call is made. The developer may create an application on the multimedia device 26 that registers a user's smartphone number and allows to send or receive calls and text messages. The flow of how the vehicle's headunit sends text message via WLAN and how the mobile provider updates the smartphone remotely is shown in FIG. 4. First, the multimedia device 26 sends an HTTP-request to a text message gateway 32. The text massage gateway 32 connects to the network cloud using text protocols. Once, the cloud server 14 receives the text protocols, it sends the data to a mobile carrier's SMSC 34. The mobile carrier updates the smartphone 16 base station controller.

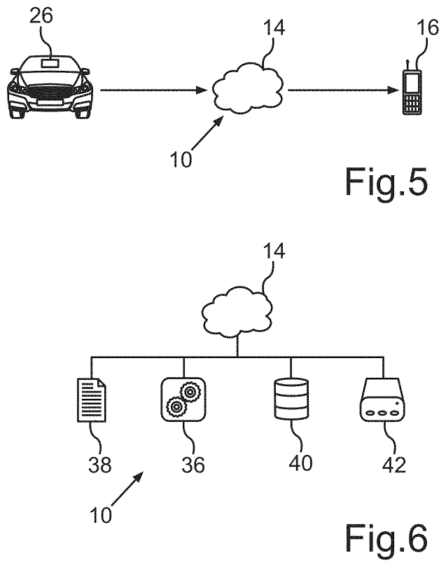

FIG. 5 shows in a schematic view another embodiment of the multimedia system 10. In FIG. 5 it is shown that an offline work with the mobile device 16 and/or the multimedia device 26 is stored and after a connection from the mobile device 16 and/or the multimedia device 26, the cloud server 14, the mobile device 16 and the multimedia device 26 are synchronized. In particular, it is shown a user data synchronization by updating the multimedia device 26 from the cloud server 14. For example, a user can synchronize their smart devices and the vehicle remotely using the cloud server 14. By using cloud server 14, user can store their data, preferences, states and update their devices or the multimedia device 26 after login. A user is able to work offline and store the changes in local data base first when there is no connectivity and update later when the connectivity is back.

FIG. 6 shows in another schematic view a multimedia system 10. Particularly, FIG. 6 shows a cloud hosted service structure. Overall, the cloud server 14 serves as a communication support for the user to be able to access smart device applications locally from the multimedia device 26. The cloud server 14 may store user data, manage credentials 36, and send/receive updates from both the multimedia device 26 and the mobile device 16. The extent of the application processing and load share between the multimedia device 26 and the cloud server 14 depends on infrastructure and bandwidth and can range from having just a user interface on the multimedia device 26 while running the application on a cloud-based service to run the application directly on the multimedia device 26. FIG. 6 shows who the cloud could connect with, the multimedia device 26 using, for example, REST IPs, messages 38, data 40 and credentials 36 using HTTPs. A user may REST IPs to access application 42 to receive or send data. User uses HTTPs to call or send messages 38.

The invention shown in FIGS. 1 to 6 also relates to a computer program comprising instructions, which, when the program is executed by the multimedia device 10, cause the multimedia system 10 to carry out the method.

This realization comes with the benefit of being able to utilize existing technologies for connectivity, security, and cloud infrastructures from service providers. For example, the user will not need to bring and connect the mobile device 16 every time to the multimedia device 26.

All in all, FIG. 1 to FIG. 6 show a cloud hosted smartphone and other IoT applications.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for operating a multimedia system for a motor vehicle, the method comprising:
establishing a first mobile network connection between a cloud server of the multimedia system and a multimedia device of the multimedia system, wherein the cloud server is external to the motor vehicle and the multimedia device is internal to the motor vehicle;
establishing a second mobile network connection between the cloud server and a mobile device of a user of the multimedia system;
transferring at least one user setting for the mobile device from the mobile device to the cloud server via the second mobile network connection;
storing the at least one user setting at the cloud server so that the multimedia device can directly access the at least one user setting by using just the first mobile network connection; and
storing, when the mobile device or the multimedia device does not have an established mobile network connection, offline work with the mobile device or the multimedia device, and after a mobile network connection from the mobile device or the multimedia device to the cloud server is subsequently established, the mobile device and the multimedia device are synchronized,
wherein at least one credential for using the at least one user setting is submitted by operating the multimedia device, and
wherein the at least one credential is stored by the multimedia device.

10. The method of claim 9, further comprising:
using, by the multimedia device, the at least one user setting while the mobile device is disconnected from the cloud server.

11. The method of claim 9, further comprising:
using, by the user operating the multimedia device, the at least one user setting.

12. The method of claim 9, further comprising:
using the at least one user setting for a phone call, a message service, mobile device applications, or data of the mobile device.

13. A non-transitory computer readable medium storing a computer program comprising instructions which, when the program is executed by a multimedia system, cause the multimedia system to:
establish a first mobile network connection between a cloud server of the multimedia system and a multimedia device of the multimedia system, wherein the cloud server is external to the motor vehicle and the multimedia device is internal to the motor vehicle;
establish a second mobile network connection between the cloud server and a mobile device of a user of the multimedia system;
transfer at least one user setting for the mobile device from the mobile device to the cloud server via the second mobile network connection;
store the at least one user setting at the cloud server so that the multimedia device can directly access the at least one user setting by using just the first mobile network connection; and
store, when the mobile device or the multimedia device does not have an established mobile network connection, offline work with the mobile device or the multimedia device, and after a mobile network connection from the mobile device or the multimedia device to the cloud server is subsequently established, the mobile device and the multimedia device are synchronized,
wherein at least one credential for using the at least one user setting is submitted by operating the multimedia device, and
wherein the at least one credential is stored by the multimedia device.

14. A multimedia system for a motor vehicle, the multimedia system comprising:
a cloud server external to the motor vehicle; and
a multimedia device internal to the motor vehicle, wherein the multimedia system is configured to
establish a first mobile network connection between a cloud server of the multimedia system and a multimedia device of the multimedia system, wherein the cloud server is external to the motor vehicle and the multimedia device is internal to the motor vehicle;
establish a second mobile network connection between the cloud server and a mobile device of a user of the multimedia system;
transfer at least one user setting for the mobile device from the mobile device to the cloud server via the second mobile network connection;
store the at least one user setting at the cloud server so that the multimedia device can directly access the at least one user setting by using just the first mobile network connection; and
store, when the mobile device or the multimedia device does not have an established mobile network connection, offline work with the mobile device or the multimedia device, and after a mobile network connection from the mobile device or the multimedia device to the cloud server is subsequently established, the mobile device and the multimedia device are synchronized,
wherein at least one credential for using the at least one user setting is submitted by operating the multimedia device, and
wherein the at least one credential is stored by the multimedia device.
